(19) United States
(12) Patent Application Publication
(10) Pub. No.: US 2015/0295650 A1
(43) Pub. Date: Oct. 15, 2015

(54) FILTER STRUCTURE FOR DRIVING AN OPTICAL MODULATOR

(71) Applicant: Alcatel-Lucent USA Inc., Murray Hill, NJ (US)

(72) Inventors: Sian Chong J. Lee, Summit, NJ (US); Ricardo A. Aroca, Springfield, NJ (US); Shahriar Shahramian, Chatham, NJ (US); Po Dong, Morganville, NJ (US)

(73) Assignee: ALCATEL-LUCENT USA INC., Murray Hill, NJ (US)

(21) Appl. No.: 14/250,978

(22) Filed: Apr. 11, 2014

(51) Int. Cl. H04B 10/2575; H04B 10/60; H04B 10/516

(52) U.S. Cl. CPC H04B 10/2575; H04B 10/516; H04B 10/60

(57) ABSTRACT

We disclose an opto-electronic circuit having an optical modulator and a driver circuit configured to generate a plurality of electrical drive signals for the optical modulator in a manner that causes the opto-electronic circuit to operate as a finite-impulse-response (FIR) filter. Different electrical drive signals generated by the driver circuit represent different taps of the FIR filter and are individually applied to different respective electrodes in the optical modulator without first being combined with one another prior to said individual application. The optical modulator represents an adder of the FIR filter and is configured to use the applied electrical drive signals to perform signal summation in the optical domain, thereby alleviating some of the limitations associated with the electrical RF circuitry used in the driver circuit. The opto-electronic circuit can be employed in optical transceivers and equalizers and be configured to implement signal pre-emphasis, feed-forward equalization, or decision-feedback equalization.

### BACKGROUND

1. Field

The present disclosure relates to optical communication equipment and, more specifically but not exclusively, to light-modulating devices that can be used in optical transmitters and/or receivers.

2. Description of the Related Art

This section introduces aspects that may help facilitate a better understanding of the disclosure. Accordingly, the statements of this section are to be read in this light and are not to be understood as admissions about what is in the prior art or what is not in the prior art.

Appropriate signal-processing methods can be used to enable optical transceivers implemented using silicon-based photonic integrated circuits (PICs) to work at bit rates that exceed the nominal limits imposed by carrier-recombination dynamics in the employed semiconductor material. For example, the pre-emphasis pulse-shaping technique can improve the inherent slow optical response of an electro-optic modulator using the rapid injection of carriers configured to provide a desired relatively high current at the pulse edges. However, commercially viable PIC solutions targeted for high-speed (e.g., >100 Gbit/s) optical transport at low-cost, low-power, and high element-integration density are not yet sufficiently developed.

### SUMMARY OF SOME SPECIFIC EMBODIMENTS

Disclosed herein are various embodiments of an opto-electronic circuit having an optical modulator and a driver circuit configured to generate a plurality of electrical drive signals for the optical modulator in a manner that causes the opto-electronic circuit to operate as a finite-impulse-response (FIR) filter. Different electrical drive signals generated by the driver circuit represent different taps of the FIR filter and are individually applied to different respective electrodes in the optical modulator without first being combined with one another prior to said individual application. The optical modulator represents an adder of the FIR filter and is configured to use the applied electrical drive signals to perform signal summation in the optical domain, thereby alleviating some of the limitations associated with the electrical RF circuitry used in the driver circuit. In various embodiments, the opto-electronic circuit can be employed in optical transmitters, equalizers, and/or receivers and be configured to implement signal pre-emphasis, feed-forward equalization, and/or decision-feedback equalization.

According to one embodiment, provided is an apparatus comprising: an optical modulator having a plurality of electrodes, each coupled to an optical waveguide of the optical modulator for modulating light therein; and a driver circuit configured to generate a plurality of electrical drive signals, each applied to a respective electrode of the plurality of electrodes, wherein the driver circuit comprises: a plurality of delay elements, each configured to generate a respective delayed copy of an electrical input signal; and a plurality of electrical amplifiers, each configured to amplify the respective delayed copy of the electrical input signal to generate a respective electrical drive signal of the plurality of electrical drive signals.

According to another embodiment, provided is a signal-processing method comprising the steps of: modulating light using an optical modulator having a plurality of electrodes, each coupled to an optical waveguide of the optical modulator for modulating light therein; generating a plurality of electrical drive signals using a driver circuit; and individually applying different electrical drive signals of the plurality of electrical drive signals to different respective electrodes of the plurality of electrodes; and wherein the step of generating comprises the sub-steps of: generating a plurality of variously delayed copies of an electrical input signal using a plurality of delay elements in the driver circuit; and amplifying each of the plurality of variously delayed copies of the electrical input signal using a respective amplifier of a plurality of electrical amplifiers in the driver circuit to generate a respective electrical drive signal of the plurality of electrical drive signals.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 shows a block diagram of an opto-electronic circuit according to an embodiment of the disclosure;

FIG. 2 shows a diagram of an optical-modulator circuit that can be used in the opto-electronic circuit of FIG. 1 according to an embodiment of the disclosure;

FIG. 3 shows a block diagram of an optical transmitter that incorporates the opto-electronic circuit of FIG. 1 according to an embodiment of the disclosure;

FIG. 4 shows a block diagram of an optical receiver that incorporates the opto-electronic circuit of FIG. 1 according to an embodiment of the disclosure;

FIG. 5 shows a block diagram of an optical equalizer that incorporates the opto-electronic circuit of FIG. 1 according to an embodiment of the disclosure; and

FIGS. 6A-6B graphically illustrate a possible eye-diagram improvement that can be achieved using the opto-electronic circuit of FIG. 1 according to an embodiment of the disclosure.

### DETAILED DESCRIPTION

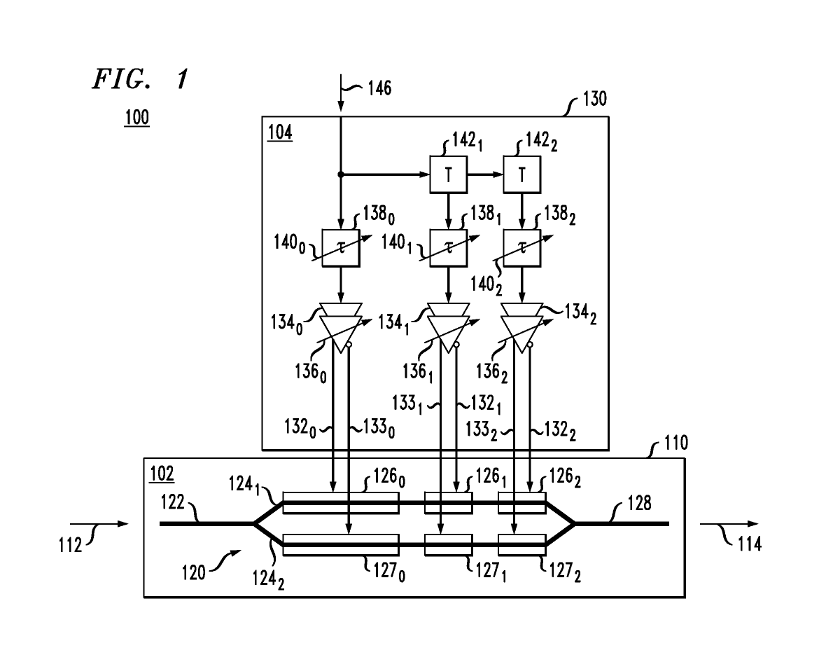

FIG. 1 shows a block diagram of an opto-electronic circuit 100 according to an embodiment of the disclosure. Circuit 100 comprises an optical-modulator circuit 110 and a driver circuit 130 configured to electrically drive the optical-modulator circuit as indicated in FIG. 1. Circuits 110 and 130 are illustratively shown as being implemented as two separate integrated circuits, each having been fabricated using a respective separate substrate (e.g., substrate 102 for circuit 110, and substrate 104 for circuit 130). However, in an alternative embodiment, circuits 110 and 130 can be further integrated and fabricated on a single common substrate (not shown in FIG. 1), e.g., using a CMOS technology.

Circuit 110 comprises a waveguide circuit that includes a Mach-Zehnder modulator 120. Modulator 120 has an input waveguide 122 configured to receive an optical input signal 112. In various embodiments, optical input signal 112 may be a CW signal or a modulated optical signal. Input waveguide 122 is further configured to direct respective portions of the received optical signal into modulator arms 124₁ and 124₂. After propagating through modulator arms 124₁ and 124₂ and being modified therein, the optical-signal portions are applied to an output waveguide 128 where they recombine to generate an optical output signal 114.

In the illustrated embodiment, modulator arm 124₁ has a plurality of electrodes 126₀-126₂, and modulator arm 124₂ has a plurality of electrodes 127₀-127₂. Each of electrodes 126₀-126₂ is configured to receive a respective one of drive signals 132₀-132₂ from driver circuit 130. Each of electrodes 127₀-127₂ is similarly configured to receive a respective one of drive signals 133₀-133₂ from driver circuit 130.

Drive signals 132₀ and 133₀ are generated by a distributed differential-output amplifier 134₀ in a manner that causes them to be inverted versions of one another. Drive signals 132₁ and 133₁ are generated by a distributed differential-output amplifier 134₁ in a similar manner. Drive signals 132₂ and 133₂ are also generated by a distributed differential-output amplifier 134₂ in a similar manner. Note however that the inverted output of amplifier 134₀ is connected to drive electrode 126₀ in arm 124₁, while the inverted outputs of amplifiers 134₁ and 134₂ are connected to drive electrodes 127₁ and 127₂ in arm 124₂.

In alternative embodiments, only one of modulator arms 124₁ and 124₂ may have a respective plurality of electrodes 126/127 connected to and driven by driver circuit 130. One of ordinary skill in the art will understand that the number of electrodes in a modulator arm may depend on the signal processing that is intended to be implemented in driver circuit 130 and the number of drive signals 132/133 generated therein. For example, in an alternative embodiment, the number of electrodes 126/127 may be different from three. Different electrodes 126/127 may or may not have the same nominal size, e.g., as illustrated in FIG. 1 by the different respective sizes of electrodes 126₀ and 126₁ and by the same size of electrodes 126₁ and 126₂.

As explained below in more detail, although based on a new design, circuit 100 is configured to implement signal processing that is analogous to the signal processing provided by a conventional 2-tap finite-impulse-response (FIR) filter. For example, driver circuit 130 is configured to process an electrical input signal 146 (e.g., carrying a binary stream of data) by performing the following FIR-filter sub-functions: (i) delaying signal 146 to generate a plurality of variously delayed signal copies, and (ii) biasing and weighting the variously delayed signal copies to generate drive signals 132₀-132₂ and 133₀-133₂. Optical-modulator circuit 110 then uses drive signals 132₀-132₂ and 133₀-133₂ to perform the summation of the optical variants of the weighted signal copies in the optical domain, rather than performing summation of the weighted signal copies themselves in the electrical domain. The latter feature of circuit 100 may be beneficial, e.g., because it simplifies the driver-circuit design by somewhat relaxing the stringent design constraints associated with the required capability to properly handle multiple electrical RF signals.

Eq. (1) gives an approximate relationship between signals 112, 114, and 132:

$$\begin{matrix}{E}_{out} ( t ) = 1 \text{/} √ 2 * {E}_{in} ( t ) \{ exp [ jπ {V}_{dr} ( t ) \text{/} {V}_{π} ] + exp [ - jπ {V}_{dr} ( t ) \text{/} {V}_{π} ] \} = \\ = √ 2 * {E}_{in} ( t ) cos [ π {V}_{dr} ( t ) \text{/} {V}_{π} ] = \\ = √ 2 * {E}_{in} ( t ) cos [ Δϕ ( t ) ]\end{matrix} \qquad ( 1 )$$

where Eₒᵤₜ is the optical field of the optical output signal 114; t is time; Eᵢₙ is the optical field of optical input signal 112; Δφ(t) is the time-varying phase difference between the optical fields in modulator arms 124₁ and 124₂; V_{π}is the peak-to-peak voltage of Mach-Zehnder modulator 120; and V_{dr}(t) is the time-varying voltage of drive signal 132. Voltage V_{dr}(t) has several components and can be expressed using Eq. (2) as follows:

$${V}_{dr} ( t ) = {V}_{bias} + {V}_{sig} ( t ) + {\sum }_{n = 1}^{N} {C}_{n} {V}_{sig} ( t - nT ) \qquad ( 2 )$$

where V_{bias} is the constant bias voltage applied to electrodes 126/127; V_{sig}(t) is the time-varying voltage that is proportional to or derived from electrical input signal 146; N is the number of taps in the portion of the FIR filter implemented by drive circuit 130; n is the summation index; T is the delay per tap; and Cₙ is the weighting coefficient corresponding to the n-th tap. V_{bias} can be set to different values, depending on how Mach-Zehnder modulator 120 is configured to modulate optical signal 112.

For example, for optical intensity modulation, V_{bias} can be set to V_{bias}=V_{π}/4. With this bias-voltage setting, the modulated intensity/power, Pₒᵤₜ, of the optical output signal field Eₒᵤₜ given by Eq. (1) can be expressed as follows:

$$\begin{matrix}{P}_{out} ( t ) = {E}_{out}^{2} ( t ) \\ = 2 {E}_{i n}^{2} ( t ) {cos}^{2} [ Δϕ ( t ) ] = \\ = {E}_{i n}^{2} ( t ) \{ 1 + cos [ 2 π {V}_{dr} ( t ) \text{/} {V}_{π} ] \}\end{matrix} \qquad ( 3 )$$

When the total swing of V_{dr}(t) is relatively small, Pₒᵤₜ in Eq. (3) can be approximated by Eq. (4) as follows:

$${P}_{out} ( t ) ∝ {V}_{sig} ( t ) + {\sum }_{n = 1}^{N} {C}_{n} {V}_{sig} ( t - nT ) \qquad ( 4 )$$

In another example configuration, V_{bias} can be set to V_{bias}=V_{π}/2. When the total swing of V_{dr}(t) is relatively small, this bias-voltage configuration results in optical-field modulation of Eₒᵤₜ in Eq. (1) and can be approximated by Eq. (5) as follows:

$${E}_{out} ( t ) ∝ {V}_{sig} ( t ) + {\sum }_{n = 1}^{N} {C}_{n} {V}_{sig} ( t - nT ) \qquad ( 5 )$$

One of ordinary skill in the art will recognize that each of Eqs. (4) and (5) describes a transfer function of an N-tap FIR filter. For the embodiment shown in FIG. 1, N=2. As already indicated above, embodiments with the number of taps N different from N=2 are also contemplated. In various embodiments, the delay time T may be equal to a symbol period or an integer multiple of the symbol period or be a fixed portion thereof.

The signal processing corresponding to Eq. (4) may be realized in circuits 110 and 130 using a distributed circuit structure, for example, as follows.

Each of fixed delay elements 142₁ and 142₂ in driver circuit 130 has a nominal delay value of T and is configured to generate a respective delayed copy of electrical input signal 146. Tunable delay elements 138₀-138₂ enable an adjustment of the relative time delays of the signal copies, e.g., when the actual time delays introduced by fixed delay elements 142₁ and 142₂ deviate from T due to the IC-fabrication process variations. Tunable delay elements 138₀-138₂ may be tuned using control signals 140₀-140₂, e.g., generated by external circuits as further described below in reference to FIGS. 3-5. In one embodiment, the tunability range τ of tunable delay elements 138₀-138₂ may be smaller than T (i.e., τ<T).

The values of weighting coefficients C, (see Eqs. (2), (4)-(5)) are determined by the relative gains of distributed electrical amplifiers 134₀-134₂ in driver circuit 130, and also by the relative sizes of electrodes 126₀-126₂ and 127₀-127₂ in optical-modulator circuit 110. In operation, the values of weighting coefficients Cₙ can be changed, e.g., by changing the gains of distributed electrical amplifiers 134₀-134₂ using control signals 136₀-136₂ received from external circuits. Note that some weighting coefficients Cₙ may have negative values. For example, for the embodiment shown in FIG. 1, weighting coefficients C₁ and C₂ have negative values with respect to the value of weighting coefficient C₀ because drive signal 132₀ is generated at the non-inverted output of amplifier 134₀ whereas each of drive signals 132₁ and 132₂ is generated at the respective inverted output of one of amplifiers 134₁ and 134₂. A similar observation applies to drive signals 133₀-133₂. In various alternative embodiments, various other combinations of inverting and non-inverting outputs configured to generate drive signals for the same interferometer arm may similarly be used to implement a desired FIR transfer function.

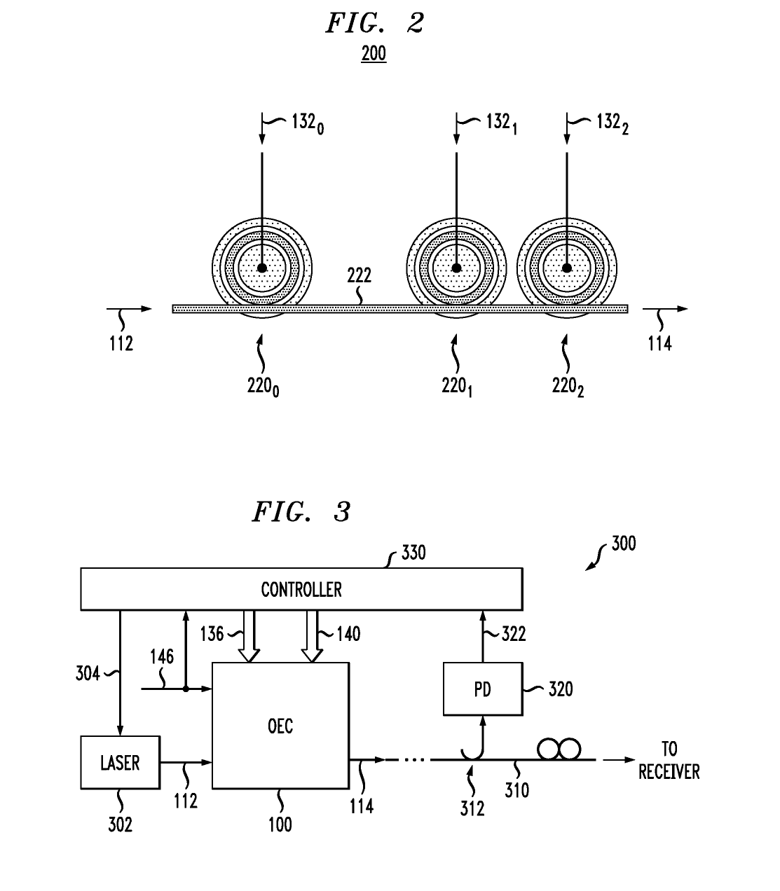

FIG. 2 shows a diagram of an optical-modulator circuit 200 that can be used in opto-electronic circuit 100 in place of an optical-modulator circuit 110 (FIG. 1) according to an embodiment of the disclosure. Circuit 200 is generally functionally analogous to circuit 110 (FIG. 1). However, one difference between circuits 110 and 200 is that the latter employs a single-ended drive configuration as opposed to the balanced drive configuration in the former. Another difference is that circuit 200 employs a plurality of optical ring modulators 220₀-220₂ instead of Mach-Zehnder modulator 120 employed in circuit 110. A waveguide 222 to which ring modulators 220₀-220₂ are coupled is configured to receive optical input signal 112 at one end thereof, and to produce optical output signal 114 at the other end thereof. The electrodes of ring modulators 220₀-220₂ are configured to receive drive signals 132₀-132₂ from driver circuit 130 as indicated in FIG. 2. One of ordinary skill in the art will understand that, by properly configuring driver circuit 130 coupled to optical-modulator circuit 200, a FIR transfer function similar to that given by Eq. (4) can be realized.

In an alternative embodiment, optical-modulator circuit 200 may have a different number of ring modulators 220 and be coupled to an embodiment of driver circuit 130 configured to generate the corresponding (different from three) number of drive signals 132.

FIG. 3 shows a block diagram of an optical transmitter 300 that incorporates opto-electronic circuit 100 (FIG. 1) according to an embodiment of the disclosure. Optical transmitter 300 has a laser 302 configured to generate optical input signal 112 for opto-electronic circuit (OEC) 100. Optical output signal 114 that is generated by opto-electronic circuit 100 based on electrical input signal 146 is then applied to an optical link (e.g., comprising an optical waveguide or fiber) 310. An optical tap 312 is configured to direct a relatively small portion (e.g., ca. 1%) of the light from optical link 310 to a photo-detector (PD) 320. Photo-detector 320 is configured to convert the received light into a corresponding electrical signal 322 and direct that electrical signal to a controller 330. Controller 330 is configured to process electrical signal 322 and, based on said processing, generate control signals 136 and 140 for opto-electronic circuit 100.

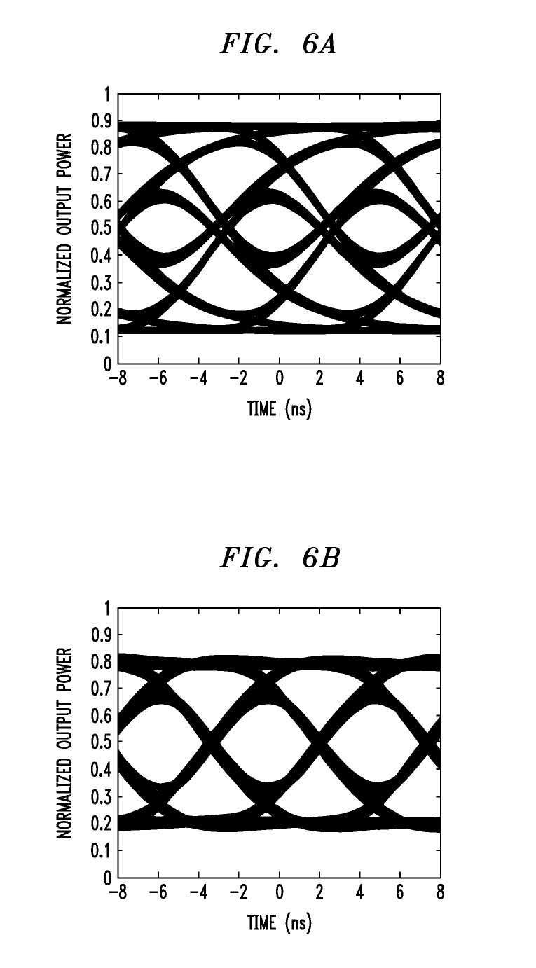

The signal processing implemented in controller 330 may depend on the location of optical tap 312 within optical link 310. For example, when optical tap 312 is placed in relatively close proximity or incorporated into opto-electronic circuit 100, the signal processing implemented in controller 330 may be directed at generating control signals 136 and 140 in a manner that configures opto-electronic circuit 100 to operate, inter alia, as a FIR pre-emphasis filter configured to alleviate the bandwidth limitations of optical-modulator circuit 110. One beneficial result of the pre-emphasis is that the optical waveform in optical output signal 114 may more accurately represent the corresponding electrical waveform applied to opto-electronic circuit 100 via electrical input signal 146, which may enable optical transmitter 300 to produce an optical output signal 114 having more advantageous (e.g., more open) eye diagram (also see FIGS. 6A-6B). Several pre-emphasis methods known to a person of ordinary skill in the art can be employed in some embodiments of controller 330 for generating control signals 136 and 140.

When optical tap 312 is placed in relatively close proximity to the intended (e.g., remote) optical receiver (not explicitly shown in FIG. 3), the signal processing implemented in controller 330 may be directed at generating control signals 136 and 140 in a manner that configures opto-electronic circuit 100 to operate, inter alia, as a feed-forward equalizer configured to mitigate the adverse effects of various signal impairments that may be accumulated over the entire optical link, including but not limited to those imposed by optical transmitter 300 itself, the optical fiber in link 310, and the front end of the optical receiver. For example, the adverse effects of dispersion and/or inter-symbol interference can be mitigated in this manner. One beneficial result of the feed-forward equalization is that the bit-error rate (BER) at the optical receiver can be lowered below the BER level exhibited when the feed-forward equalization is not employed. Several feed-forward equalization methods that can be employed in some embodiments of controller 330 for generating control signals 136 and 140 are disclosed, e.g., in U.S. Pat. No. 7,471,904, and U.S. Patent Application Publication No. 2013/0236195, both of which are incorporated herein by reference in their entirety.

In some embodiments, controller 330 may also be configured to receive a copy of electrical input signal 146, e.g., as indicated in FIG. 3. Controller 330 may use signal 146 to generate a control signal for laser 302, e.g., for appropriately gating the optical output signal 112 generated by the laser.

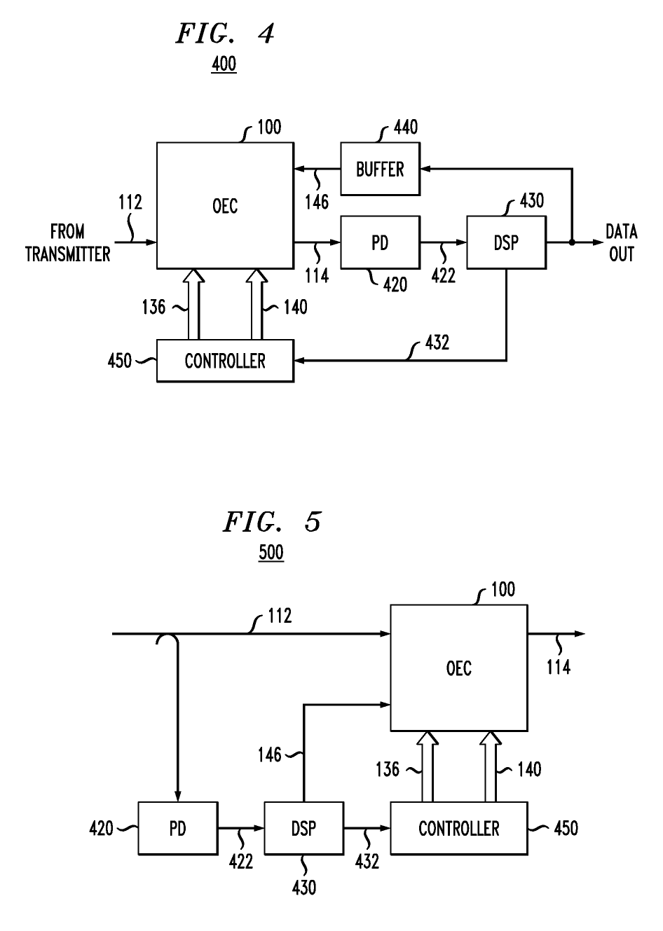

FIG. 4 shows a block diagram of an optical receiver 400 that incorporates opto-electronic circuit 100 (FIG. 1) according to an embodiment of the disclosure. Optical receiver 400 is configured to receive an optical input signal from a corresponding optical transmitter (e.g., optical transmitter 300, FIG. 3). The received optical signal serves as optical input signal 112 applied to opto-electronic circuit 100 in receiver 400. Optical output signal 114 generated by opto-electronic circuit 100 in receiver 400 is applied to a photo-detector (PD) 420. Photo-detector 420 is configured to convert the received light into a corresponding electrical signal 422 and direct that electrical signal to a digital signal processor (DSP) 430. DSP 430 is configured to process electrical signal 422 to recover the data encoded in optical input signal 112. The recovered data are buffered (e.g., delayed) in an optional buffer 440 and then fed back into opto-electronic circuit 100 as electrical input signal 146. In the process of recovering the data, DSP 430 may also generate a suitable performance metric (e.g., measure the signal-to-noise ratio, SNR) 432 and provide said performance metric to a controller 450. Based on performance metric 432, controller 450 generates control signals 136 and 140 in a manner that configures opto-electronic circuit 100 to operate, inter alia, as a decision-feedback equalizer, e.g., configured to mitigate the adverse effects of various signal impairments that may have affected optical input signal 112 in the corresponding optical transport link and to enable optical receiver 400 to achieve and/or maintain a desired value of performance metric 432. Several decision-feedback equalization methods known to a person of ordinary skill in the art can be employed in some embodiments of controller 450 for generating control signals 136 and 140.

FIG. 5 shows a block diagram of an optical equalizer 500 that incorporates opto-electronic circuit 100 (FIG. 1) according to an embodiment of the disclosure. Optical equalizer 500 reuses some of the elements of optical receiver 400, and the description of these elements is not repeated here. Based on performance metric 432, controller 450 in optical equalizer 500 generates control signals 136 and 140 in a manner that configures opto-electronic circuit 100 to improve the eye diagram of optical output signal 114 compared to the eye diagram of optical input signal 112. An example eye-diagram improvement that can be achieved in this manner is shown in FIGS. 6A-6B.

FIGS. 6A-6B graphically illustrate a possible eye-diagram improvement that can be achieved using opto-electronic circuit 100 according to an embodiment of the disclosure. More specifically, the simulated eye diagrams shown in FIGS. 6A-6B correspond to an embodiment of opto-electronic circuit 100 in which driver circuit 130 has a single tap, and the opto-electronic circuit is configured to operate as 1-tap FIR pre-emphasis filter using the configuration shown in FIG. 3. FIG. 6A graphically shows the eye diagram of optical output signal 114 when the pre-emphasis is turned OFF. FIG. 6B graphically shows the eye diagram of optical output signal 114 under the same operating conditions as in FIG. 6A, but with the pre-emphasis turned ON. Comparison of the eye diagrams shown in FIGS. 6A-6B reveals the beneficial eye opening due to the pre-emphasis filtering implemented in opto-electronic circuit 100.

According to an example embodiment disclosed above in reference to FIGS. 1-6, provided is an apparatus comprising: an optical modulator (e.g., 120, FIG. 1; 200, FIG. 2) having a plurality of electrodes (e.g., 126₀-126₂, 127₀-127₂, FIG. 1), each coupled to a respective one of first and second optical waveguides (e.g., in 124₁, 124₂, FIG. 1) of the optical modulator for modulating light therein; and a driver circuit (e.g., 130, FIG. 1) configured to generate a plurality of electrical drive signals (e.g., 132₀-132₂, 133₀-133₂, FIG. 1), each applied to a respective electrode of the plurality of electrodes. The driver circuit comprises: a plurality of delay elements (e.g., 138₀-138₂, 142₁-142₂, FIG. 1), each configured to generate a respective delayed copy of an electrical input signal (e.g., 146, FIG. 1); and a plurality of electrical amplifiers (e.g., 134₀-134₂, FIG. 1), each configured to amplify the respective delayed copy of the electrical input signal to generate a respective electrical drive signal of the plurality of electrical drive signals.

In some embodiments of the above apparatus, the optical modulator is a Mach-Zehnder modulator (e.g., 120, FIG. 1).

In some embodiments of any of the above apparatus, a first modulator arm (e.g., 124₁, FIG. 1) of the Mach-Zehnder modulator includes at least two electrodes of the plurality of electrodes.

In some embodiments of any of the above apparatus, a second modulator arm (e.g., 124₂, FIG. 1) of the Mach-Zehnder modulator includes at least one other electrode (e.g., 127₀-127₂, FIG. 1) of the plurality of electrodes.

In some embodiments of any of the above apparatus, at least two electrodes (e.g., 126₀ and 126₂, FIG. 1) of the plurality of electrodes have different respective sizes (e.g., different respective electrode lengths along the waveguide), and at least two electrodes (e.g., 126₁ and 126₂, FIG. 1) of the plurality of electrodes have a same size (e.g., the same length along the waveguide).

In some embodiments of any of the above apparatus, the optical modulator comprises a plurality of ring modulators (e.g., 220₀-220₂, FIG. 2), each including the respective electrode of the plurality of electrodes.

In some embodiments of any of the above apparatus, the plurality of delay elements comprises at least one fixed delay element (e.g., 142, FIG. 1) and at least one tunable delay element (e.g., 138, FIG. 1).

In some embodiments of any of the above apparatus, the plurality of electrical amplifiers comprises at least one inverted output (e.g., for generating 132ᵢ, FIG. 1) and at least one non-inverted output (e.g., for generating 133ᵢ, FIG. 1), wherein an electrical amplifier having said at least one inverted output and an electrical amplifier having said at least one non-inverted output are configured to receive different respective delayed copies of the electrical input signal from different respective delay elements of the plurality of delay elements.

In some embodiments of any of the above apparatus, each of the plurality of electrical amplifiers is controllable to have an individually variable amplifier gain (e.g., controllable via one of 136₀-136₂, FIG. 1).

In some embodiments of any of the above apparatus, the driver circuit is configured to individually apply different electrical drive signals of the plurality of electrical drive signals to different respective electrodes of the plurality of electrodes, without combining one of the different electrical drive signals with other one or more of the different electrical drive signals prior to said individual application.

In some embodiments of any of the above apparatus, the optical modulator and the driver circuit are configured to operate as a finite-impulse-response (FIR) filter (e.g., in accordance with Eqs. (1)-(3)) configured to filter the electrical input signal to generate a corresponding optical output signal (e.g., 114, FIG. 1). The plurality of electrical drive signals represent one or more taps of the FIR filter. The optical modulator represents an adder of the FIR filter and is configured to use the plurality of electrical drive signals to perform an optical summation of optical variants of variously delayed and weighted copies of the electrical input signal to generate said corresponding optical output signal.

In some embodiments of any of the above apparatus, the FIR filter has a transfer function that is variable via a change of individual amplifier gains in the plurality of electrical amplifiers.

In some embodiments of any of the above apparatus, the apparatus further comprises an electronic controller (e.g., 330, FIG. 3; 450, FIGS. 4-5) configured to individually vary amplifier gains of different amplifiers in the plurality of electrical amplifiers.

In some embodiments of any of the above apparatus, the electronic controller is further configured to individually vary delays of at least some delay elements in the plurality of delay elements.

In some embodiments of any of the above apparatus, the apparatus comprises an optical transmitter (e.g., 300, FIG. 3) that includes the optical modulator, the driver circuit, and the electronic controller.

In some embodiments of any of the above apparatus, the apparatus further comprises a photo-detector (e.g., 320, FIG. 3) configured to receive light from the optical modulator to generate a corresponding electrical signal (e.g., 322, FIG. 3), wherein the electronic controller is further configured to individually vary the amplifier gains based on said corresponding electrical signal.

In some embodiments of any of the above apparatus, the apparatus further comprises a photo-detector (e.g., 420, FIG. 5) coupled to an optical tap configured to tap the light applied to the optical modulator, said photo-detector configured to convert the tapped light into a corresponding electrical signal (e.g., 420, FIG. 5), wherein the electronic controller is further configured to individually vary the amplifier gains based on said corresponding electrical signal.

In some embodiments of any of the above apparatus, the apparatus comprises an optical receiver (e.g., 400, FIG. 4) that includes the optical modulator, the driver circuit, and the electronic controller.

In some embodiments of any of the above apparatus, the optical receiver further includes: a photo-detector (e.g., 420, FIG. 4) configured to receive light from the optical modulator to generate a corresponding electrical signal (e.g., 422, FIG. 4); and a signal processor (e.g., 430, FIG. 4) configured to process said corresponding electrical signal to recover data encoded in the light received by the photo-detector and further configured to generate a performance metric (e.g., 432, FIG. 4) that characterizes performance of the optical receiver. The electronic controller is further configured to individually vary the amplifier gains based on said performance metric.

In some embodiments of any of the above apparatus, the optical receiver further includes a feedback path (e.g., via 440, FIG. 4) configured to feed the recovered data back into the driver circuit via the electrical input signal.

In some embodiments of any of the above apparatus, the optical modulator and the driver circuit have been fabricated on a common substrate (e.g., replacing the combined 102 and 104, FIG. 1) using a CMOS technology.

According to another example embodiment disclosed above in reference to FIGS. 1-6, provided is a signal-processing method comprising the steps of: modulating light using an optical modulator (e.g., 120, FIG. 1; 200, FIG. 2) having a plurality of electrodes (e.g., 126₀-126₂, FIG. 1), each coupled to an optical waveguide (e.g., in 124₂, FIG. 1) of the optical modulator for modulating light therein; generating a plurality of electrical drive signals (e.g., 132₀-132₂, FIG. 1) using a driver circuit (e.g., 130, FIG. 1); and individually applying different electrical drive signals of the plurality of electrical drive signals to different respective electrodes of the plurality of electrodes, without combining one of the different electrical drive signals with any other of the different electrical drive signals prior to said individual application. The step of generating comprises the sub-steps of: generating a plurality of variously delayed copies of an electrical input signal (e.g., 146, FIG. 1) using a plurality of delay elements (e.g., 138₀-138₂, 142₁-142₂, FIG. 1) in the driver circuit; and amplifying each of the plurality of variously delayed copies of the electrical input signal using a respective amplifier of a plurality of electrical amplifiers (e.g., 134₀-134₂, FIG. 1) in the driver circuit to generate a respective electrical drive signal of the plurality of electrical drive signals.

While this disclosure includes references to illustrative embodiments, this specification is not intended to be construed in a limiting sense.

Although Eqs. (1)-(3) describe an embodiment directed at the generation of intensity-modulated optical signals, contemplated embodiments are not so limited. From the provided description, one of ordinary skill in the art will understand how to modify and/or configure circuit 100 (FIG. 1) for the generation of phase-modulated optical signals.

Various embodiments may employ any of silicon photonics circuits, Lithium-Niobate waveguide circuits, and/or other suitable types of electro-optical modulators.

Although illustrative embodiments have been described in reference to Mach-Zehnder modulator 120 shown in FIG. 1, single-drive with a push-pull configuration, as well as differential drive where both branches of the Mach-Zehnder modulator are driven by amplifiers of a distributed filter structure similar to that of driver circuit 130 are also contemplated.

Electrodes in different embodiments of the electro-optical modulator (such as modulator 120 or 200) may have different suitable sizes and different suitable inter-electrode distances compatible with the intended application of circuit 100.

In an alternative embodiment, an optical receiver of the disclosure may have more than one instance (copy) of circuit 100, e.g., with each copy being configured to process light of a different respective polarization or wavelength. To enable these functions of the optical receiver, the receiver structure may incorporate one or more polarization beam splitters and/or combiners, or a polarization controller, and/or wavelength division de-multiplexing and multiplexing devices. Similar modifications can be applied to an optical transmitter of the disclosure as well.

Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments may be implemented as circuit-based processes, including possible implementation on a single integrated circuit.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this disclosure may be made by those skilled in the art without departing from the scope of the disclosure, e.g., as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The description and drawings merely illustrate the principles of the disclosure. It will thus be appreciated that those of ordinary skill in the art will be able to devise various arrangements that, although not explicitly described or shown herein, embody the principles of the disclosure and are included within its spirit and scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

What is claimed is:

1. An apparatus comprising:
an optical modulator having a plurality of electrodes, each coupled to an optical waveguide of the optical modulator for modulating light therein; and
a driver circuit configured to generate a plurality of electrical drive signals, each applied to a respective electrode of the plurality of electrodes, wherein the driver circuit comprises:
a plurality of delay elements, each configured to generate a respective delayed copy of an electrical input signal; and
a plurality of electrical amplifiers, each configured to amplify the respective delayed copy of the electrical input signal to generate a respective electrical drive signal of the plurality of electrical drive signals.

2. The apparatus of claim 1,
wherein the optical modulator is a Mach-Zehnder modulator; and
wherein a first modulator arm of the Mach-Zehnder modulator includes at least two electrodes of the plurality of electrodes.

3. The apparatus of claim 2, wherein a second modulator arm of the Mach-Zehnder modulator includes at least one other electrode of the plurality of electrodes.

4. The apparatus of claim 1, wherein at least two electrodes of the plurality of electrodes have different respective sizes, and at least two electrodes of the plurality of electrodes have a same size.

5. The apparatus of claim 1, wherein the optical modulator comprises a plurality of ring modulators, each including the respective electrode of the plurality of electrodes.

6. The apparatus of claim 1, wherein the plurality of delay elements comprises at least one fixed delay element and at least one tunable delay element.

7. The apparatus of claim 1, wherein the plurality of electrical amplifiers comprises at least one inverted output and at least one non-inverted output, wherein an electrical amplifier having said at least one inverted output and an electrical amplifier having said at least one non-inverted output are configured to receive different respective delayed copies of the electrical input signal from different respective delay elements of the plurality of delay elements.

8. The apparatus of claim 1, wherein each of the plurality of electrical amplifiers is controllable to have an individually variable amplifier gain.

9. The apparatus of claim 1, wherein the driver circuit is configured to individually apply different electrical drive signals of the plurality of electrical drive signals to different respective electrodes of the plurality of electrodes, without combining one of the different electrical drive signals with other one or more of the different electrical drive signals prior to said individual application.

10. The apparatus of claim 1, wherein the optical modulator and the driver circuit are configured to operate as a finite-impulse-response (FIR) filter configured to filter the electrical input signal to generate a corresponding optical output signal, wherein:
the plurality of electrical drive signals represent one or more taps of the FIR filter; and
the optical modulator represents an adder of the FIR filter and is configured to use the plurality of electrical drive signals to perform an optical summation of optical variants of variously delayed and weighted copies of the electrical input signal to generate said corresponding optical output signal.

11. The apparatus of claim 10, wherein the FIR filter has a transfer function that is variable via a change of individual amplifier gains in the plurality of electrical amplifiers.

12. The apparatus of claim 1, further comprising an electronic controller configured to individually vary amplifier gains of different amplifiers in the plurality of electrical amplifiers.

13. The apparatus of claim 12, wherein the electronic controller is further configured to individually vary delays of at least some delay elements in the plurality of delay elements.

14. The apparatus of claim 12, comprising an optical transmitter that includes the optical modulator, the driver circuit, and the electronic controller.

15. The apparatus of claim 14, further comprising a photo-detector configured to receive light from the optical modulator to generate a corresponding electrical signal, wherein the electronic controller is further configured to individually vary the amplifier gains based on said corresponding electrical signal.

16. The apparatus of claim 12, further comprising a photo-detector coupled to an optical tap configured to tap the light applied to the optical modulator, said photo-detector configured to convert the tapped light into a corresponding electrical signal, wherein the electronic controller is further configured to individually vary the amplifier gains based on said corresponding electrical signal.

17. The apparatus of claim 12, comprising an optical receiver that includes the optical modulator, the driver circuit, and the electronic controller.

18. The apparatus of claim 17,
wherein the optical receiver further includes:
a photo-detector configured to receive light from the optical modulator to generate a corresponding electrical signal; and
a signal processor configured to process said corresponding electrical signal to recover data encoded in the light received by the photo-detector and further configured to generate a performance metric that characterizes performance of the optical receiver;
wherein the electronic controller is further configured to individually vary the amplifier gains based on said performance metric; and
wherein the optical receiver further includes a feedback path configured to feed the recovered data back into the driver circuit via the electrical input signal.

19. The apparatus of claim 1, wherein the optical modulator and the driver circuit have been fabricated on a common substrate using a CMOS technology.

20. A signal-processing method comprising:
modulating light using an optical modulator having a plurality of electrodes, each coupled to an optical waveguide of the optical modulator for modulating light therein;
generating a plurality of electrical drive signals using a driver circuit; and
individually applying different electrical drive signals of the plurality of electrical drive signals to different respective electrodes of the plurality of electrodes; and
wherein the step of generating comprises:
generating a plurality of variously delayed copies of an electrical input signal using a plurality of delay elements in the driver circuit; and
amplifying each of the plurality of variously delayed copies of the electrical input signal using a respective amplifier of a plurality of electrical amplifiers in the driver circuit to generate a respective electrical drive signal of the plurality of electrical drive signals.
